(19) United States
(12) Patent Application Publication
(10) Pub. No.: US 2009/0218230 A1
(43) Pub. Date: Sep. 3, 2009

(54) METHOD OF PRODUCING ELECTRONIC COMPONENT

(76) Inventor: Tadashi Iijima, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/369,794

(22) Filed: Feb. 12, 2009

(30) Foreign Application Priority Data
Feb. 28, 2008 (JP) P2008-047950

(51) Int. Cl. H01B 13/00; C25D 5/00; C23C 28/02

(52) U.S. Cl. 205/85; 216/13; 205/184

(57) ABSTRACT

A method of producing an electronic component includes forming a film of a first metal above a substrate; converting partly the film of the first metal into a film containing a second metal by replacement of at least part of the first metal with the second metal; forming a film of a third metal above the film containing the second metal; and removing the film of the first metal other than the film containing the second metal by wet etching using the film of the third metal as a mask.

### CROSS-REFERENCE TO THE RELATED APPLICATIONS

This application is based upon and claims the benefit of priority from the prior Japanese Patent Application No. 2008-047950 filed on Feb. 28, 2008; the entire contents of which are incorporated herein by reference.

### BACKGROUND OF THE INVENTION

The present invention relates to a method of producing an electronic component having a connection terminal composed of a solder bump.

There is a conventionally known technology to perform flip-chip connection of a semiconductor chip and an interposer substrate such as a BGA substrate via a solder bump formed on the semiconductor chip. Heretofore, a Pb-based solder such as a Sn—Pb solder has been used for the solder bumps, but it is now being replaced by a lead-free solder (for example, Sn—Cu, Sn—Ag—Cu, etc.) not containing Pb in view of environmental protection measures in these years.

As a method of forming such a lead-free solder bump, there is proposed a method of forming a Sn—Cu solder bump or a Sn—Ag—Cu solder bump by forming a layer of a solder-composing element Cu as an under bump metal (UBM) layer on a substrate by sputtering or the like, depositing a Sn solder or a Sn—Ag solder thereon by electrolytic plating, and reflowing to dissolve Cu in the UBM layer into the solder when the solder is reflowed. This method takes in the second or third element Cu of the solder from the UBM layer to decrease the number of plating elements, thereby simplifying the plating process. Specifically, the plating process becomes complex in terms of the maintenance of the chemical properties of a plating solution and the precise control of the compositions as the number of plating elements increases. It is considered that such complex management and control can be simplified by decreasing the number of plating elements.

The above method needs to remove the UBM layer from the portion other than the bump forming portion after plating the Sn solder or Sn—Ag solder. To remove the UBM layer, wet etching, dry etching or the like is used, but the wet etching is suitable in terms of productivity and economic efficiency because it has a fast processing speed. However, when the wet etching is used, etching proceeds isotropically, and relatively large undercuts are produced in the UBM layer (Cu layer) below the plating layer. As a result, the final composition of solder bumps is varied to change the melting point or to lower the mechanical strength, possibly causing a decrease in mounting yield. The solder bumps are arranged in a narrow pitch pattern (e.g., 50 μm or below) in these years and therefore an effect of the undercuts on the solder composition is particularly large. Besides, if an amount of an undercut becomes large, a diameter of the bump after the solder reflow becomes small, its control becomes difficult, adhesiveness to the substrate lowers, and peeling becomes easy to occur. Thus, the above-described method using wet etching cannot be applied to the formation of narrow pitch-patterned solder bumps, and therefore, there remains a problem that productivity and economic efficiency cannot be improved.

### BRIEF SUMMARY OF THE INVENTION

According to an aspect of the present invention, there is provided a method of producing an electronic component, comprising forming a film of a first metal above a substrate; converting partly the film of the first metal into a film containing a second metal by replacement of at least part of the first metal with the second metal; forming a film of a third metal above the film containing the second metal; and removing the film of the first metal other than the film containing the second metal by wet etching using the film of the third metal as a mask.

### BRIEF DESCRIPTION OF THE DRAWINGS

FIG. 1A to FIG. 1G are sectional views showing a process of a method of producing an electronic component according to a first embodiment.

FIG. 2 is a sectional view showing an example of generation of an undercut in comparison with the first embodiment.

### DETAILED DESCRIPTION OF THE INVENTION

Embodiments of the present invention are described with reference to the drawings, which are provided for illustration only, and the present invention is not limited to the drawings.

### First Embodiment

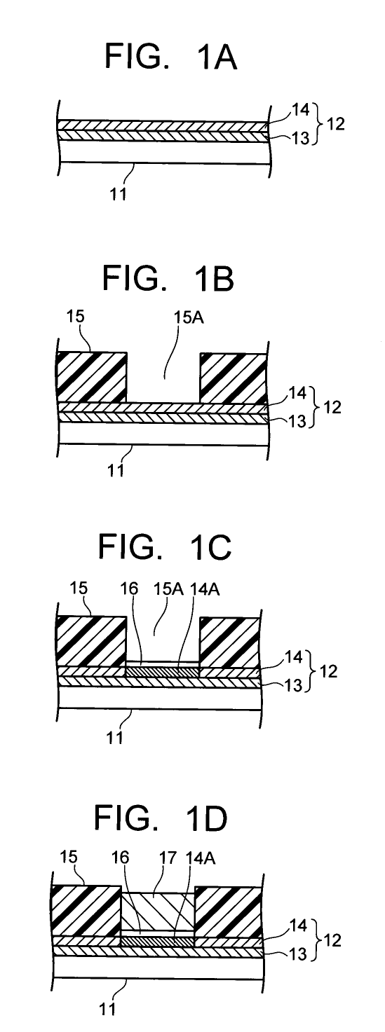

A first embodiment is described below. FIG. 1A to FIG. 1G are sectional views showing an process for an electronic component production according to this embodiment. In this embodiment, formation of bumps of a Sn—Ag—Cu ternary lead-free solder or a Sn—Ag binary lead-free solder on an electronic component is described.

As shown in FIG. 1A, a Ti film 13 with a thickness of e.g. 5000-angstrom and a Cu film 14 with a thickness of e.g. 1 μm are sequentially formed as an UBM layer 12 by methods other than electrolytic plating such as electroless plating, vapor deposition or sputtering on a substrate 11 of an electronic component such as a semiconductor chip, on which unshown electrode pad and passivation film are arranged. A first layer of the UBM layer 12 may be composed of Ti, Ta, W, Cr, V, Zr, Ni, or alloys or compounds resulting from combining any two or more thereof and may also have a laminated structure having such films laminated in plural.

As shown in FIG. 1B, a resist film 15 with a thickness of, for example, 70 μm is laminated on the Cu film 14 by a spin coating technique, and then an octagonal opening 15A having, for example, a circumscribing circle with a diameter of 100 μm is formed in the resist film 15, at only a portion where a bump is formed, by a lithography technique.

As shown in FIG. 1C, when electric current is passed through the UBM layer 12 (Cu layer 14) and an Ag plating solution is also supplied into the opening 15A, a film 16 composed of Ag, a nobler metal than Cu, is formed by electrolytic plating on the Cu film 14 exposed at the bottom of the opening 15A. At this time, before electric current is passed through the UBM layer 12, displacement plating is performed to displace at least part of Cu with Ag, using electric potential difference between Cu and Ag, so that the portion exposed at the bottom of the opening 15A of the Cu film 14 is selectively converted into a film 14A composed of Cu—Ag (or Ag). Then, electric current is started to pass to form the Ag film 16 having a thickness of, for example, 1 μm.

A ratio of Cu replaced by Ag and a thickness of the Ag film 16 to be formed are appropriately determined according to the composition of the solder bumps to be formed finally. Therefore, it is also possible to perform only the displacement plating without forming the Ag film 16, and a Sn film 17 described later is formed just above the Cu—Ag (or Ag) film 14A. When Cu has been partly replaced by Ag, heat treatment may be subsequently performed to make alloying or compounding. Alloying or compounding provides an advantage that etching selectivity can be further enhanced for Cu wet etching as described later.

As shown in FIG. 1D, when electric current is passed through the UBM layer 12 and a Sn plating solution is also supplied into the opening 15A, Sn film 17 with a thickness of, for example, 50 μm is formed by electrolytic plating on the Ag film 16 or the Cu—Ag (or Ag) film 14A exposed at the bottom of the opening 15A. The thickness of the Sn film 17 is also determined appropriately according to the composition of the solder bumps to be formed finally. The Sn film 17 may be formed by a generally known method such as vapor deposition, sputtering or electroless plating other than electrolytic plating.

As shown in FIG. 1E, after the resist film 15 is removed by a chemical agent such as a resist stripping solution, the Cu film 14 is removed by wet etching using the Sn film 17 or the Sn film 17 and the Ag film 16 as a mask. A solution which dissolves Cu but does not dissolve or is at least harder to dissolve Ag than Cu is used as an etching solution, which includes an ammonia-hydrogen peroxide mixture, a sulfuric acid-hydrogen peroxide mixture and a phosphoric acid-hydrogen peroxide mixture. Specifically, a WLC-C (trade name) manufactured by MITSUBISHI GAS CHEMICAL COMPANY, INC. or the like available on the market as an etching solution for Cu is preferably used. Use of such an etching solution selectively removes the Cu film 14 only and can suppress or prevent the generation of an undercut below the Sn film 17 and the Ag film 16 involved in wet etching.

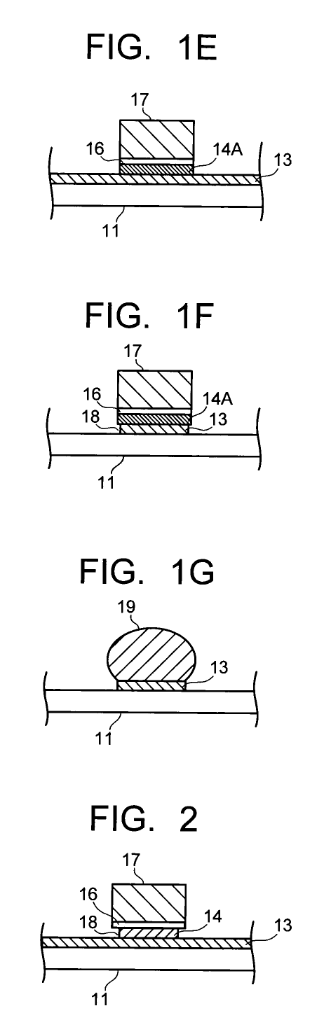

FIG. 2 shows an example of subjecting the Cu film 14 to the wet etching process after forming a film in the same manner as in the present embodiment except that the Ag film 16 and the Sn film 17 are formed on the Cu film 14 without forming the Cu—Ag (or Ag) film 14A, and it is seen that an undercut 18 of the Cu film 14 is generated below the Sn film 17 and the Ag film 16. In this embodiment, a portion exposed at the bottom of the opening 15A in the Cu film 14 is selectively converted into the film 14A comprising Cu—Ag (or Ag), and an etching solution which dissolves Cu but does not dissolve or is hard to dissolve at least Ag is used, so that only the Cu film 14 can be removed selectively, and the generation of an undercut below the Sn film 17 and the Ag film 16 can be suppressed or prevented.

As shown in FIG. 1F, the first layer of the UBM layer 12, the Ti film 13, which is exposed by removing the Cu film 14, is removed by wet etching, using the Sn film 17, the Ag film 16 and the Cu—Ag (or Ag) film 14A as a mask. The etching solution is desired not to dissolve the Sn film 17, the Ag film 16 and the Cu—Ag (or Ag) film 14A. For example, a diluted hydrofluoric acid solution diluted to about 0.5 to 1 wt %, a KOH and hydrogen peroxide solution or a WLC-T (trade name) available on the market as an etching solution for Ti and manufactured by MITSUBISHI GAS CHEMICAL COMPANY, INC. is preferably used. Different from the Cu film 14 which has the Cu—Ag (or Ag) film 14A formed, the Ti film 13 is entirely homogeneous, so that the undercut 18 is generated below the Cu—Ag (or Ag) film 14A. But, its amount does not become a problem in practical use because, for example, a distance between an end of the Cu—Ag (or Ag) film 14A and an end of the Ti film 13 after wet etching is as small as, for example, about 0.1 μm, having no effect on the final composition of the solder bumps.

Then, as shown in FIG. 1G, an ordinary solder reflow process is conducted. This process produces a eutectic alloy of the Sn film 17, the Ag film 16 and the Cu—Ag (or Ag) film 14A to form a Sn—Ag—Cu ternary or Sn—Ag binary solder bump 19 corresponding to a component ratio of individual elements Sn, Ag and Cu. The reflow process may be performed before the Ti film 13 is removed. In this case, the Sn—Ag—Cu ternary or Sn—Ag binary solder bump 19 is used as a mask for wet etching of the Ti film 13.

In this embodiment, since the solder bump formed portion of the Cu film 14 formed as the UBM layer 12 is converted into the Cu—Ag (or Ag) film 14A, when the Cu film 14 of the portion other than the solder bump formed portion is removed by the wet etching method, only the Cu film 14 to be removed can be removed selectively, and the generation of undercuts can be suppressed or prevented. Thus, the final composition of the solder bump can be precisely controlled, and a decrease in mounting yield due to a change in melting point or a decrease in mechanical strength or adhesiveness can be prevented. Even if the solder bumps have a narrow pitch pattern, their final compositions and dimensions can be precisely controlled, so that it becomes possible to apply the wet etching to the Cu film etching, productivity of an electronic component including the narrow pitch-patterned solder bumps can be improved, and the production cost can be reduced.

### Other Embodiments

In the first embodiment, it was described that the bumps of the Sn—Ag—Cu ternary lead-free solder or the Sn—Ag binary lead-free solder were formed. But, in a case where bumps are formed of a solder not having the above composition, the embodiment can also be applied extensively by appropriately selecting the materials and processes.

For example, when an Au film is formed instead of the Ag film 16 in the first embodiment, bumps can be formed of a Sn—Au—Cu ternary lead-free solder or a Sn—Au binary lead-free solder. When a Bi film is formed instead of the Cu film 14, the bumps can be formed of a Sn—Ag—Bi ternary lead-free solder or a Sn—Ag binary lead-free solder. In this case, when an Au film is formed instead of the Ag film 16, the bumps can be formed of a Sn—Au—Bi ternary lead-free solder or a Sn—Au binary lead-free solder. When an Ag film is formed instead of the Cu film 14 and an Au film is formed instead of the Ag film 16, the bumps can be formed of a Sn—Au—Ag ternary lead-free solder or a Sn—Au binary lead-free solder.

It is also possible to form one or more films of other metals on/under the Sn film 17. Thus, it is possible to form bumps of a quarternary or more solder (e.g., Sn—Ag—In—Bi).

In the first embodiment, the process of converting the Cu film 14 partly into the Cu—Ag (or Ag) film 14A was performed by the displacement plating method. But, the above process is not exclusive if the conversion into the Cu—Ag (or Ag) film 14A, namely the Ag-containing film can be performed. When the displacement plating method is used, it is necessary that the metal (Cu, Bi or the like) to be replaced is electrochemically less noble than the replacing metal, but if another method is applied, such limitation is eliminated, and flexibility of selection of metal species can be increased.

The present invention is not limited to the descriptions of the embodiments described above. The structure, material quality, arrangement of individual members and the like can be modified appropriately without departing from the spirit and scope of the invention.

What is claimed is:

1. A method of producing an electronic component, comprising:
forming a film of a first metal above a substrate;
converting partly the film of the first metal into a film containing a second metal by replacement of at least part of the first metal with the second metal;
forming a film of a third metal above the film containing the second metal; and
removing the film of the first metal other than the film containing the second metal by wet etching using the film of the third metal as a mask.

2. The method of producing an electronic component according to claim 1, wherein the wet etching is performed using an etching solution which dissolves the first metal but does not dissolve or is harder to dissolve the second metal than the first metal.

3. The method of producing an electronic component according to claim 1, wherein the first metal is less noble than the second metal.

4. The method of producing an electronic component according to claim 3, wherein the replacement is performed by displacement plating.

5. The method of producing an electronic component according to claim 1, wherein the film containing the second metal comprises the first and the second metals.

6. The method of producing an electronic component according to claim 5, further comprising performing heat treatment of the film containing the second metal to convert it into a film of an alloy or a compound comprising the first and the second metals.

7. The method of producing an electronic component according to claim 1, wherein the film containing the second metal consists essentially of the second metal.

8. The method of producing an electronic component according to claim 5, wherein the first metal is a metal capable of forming a eutectic alloy together with the second and third metals.

9. The method of producing an electronic component according to claim 7, wherein the second metal is a metal capable of forming a eutectic alloy together with the third metal.

10. The method of producing an electronic component according to claim 1, wherein the first metal is Cu or Bi.

11. The method of producing an electronic component according to claim 1, wherein the second metal is Ag or Au.

12. The method of producing an electronic component according to claim 1, wherein the third metal is Sn.

13. The method of producing an electronic component according to claim 1, wherein the film of the first metal is formed by a method other than electrolytic plating.

14. The method of producing an electronic component according to claim 1, wherein the film of the third metal is formed by electrolytic plating.

15. The method of producing an electronic component according to claim 1, wherein the film of the third metal is formed above the film containing the second metal with a film of the second metal held between them.

16. The method of producing an electronic component according to claim 15, wherein the film of the second metal is formed by electrolytic plating.

17. The method of producing an electronic component according to claim 1, further comprising forming a film of a fourth metal on/under the film of the third metal.

18. The method of producing an electronic component according to claim 1, wherein the substrate is provided with a film thereon comprising a material selected from the group consisting of Ti, Ta, W, Cr, V, Zr, Ni and alloys or compounds resulting from combining any two or more thereof, and the film of the first metal is formed on the film comprising the material on the substrate.

19. The method of producing an electronic component according to claim 18, further comprising removing, by wet etching using the film of the third metal as a mask after removing the film of the first metal, the film comprising the material which has been exposed by removing the film of the first metal.

20. The method of producing an electronic component according to claim 18, further comprising forming a bump on the film comprising the material by reflow processing after removing the film of the first metal and removing, by wet etching using the bump as a mask, the film comprising the material which has been exposed by removing the film of the first metal.
